(19) United States
(12) Patent Application Publication
(10) Pub. No.: US 2018/0216876 A1
(43) Pub. Date: Aug. 2, 2018

(54) APPARATUS AND METHOD FOR BOIL-OFF GAS RELIQUEFACTION

(71) Applicant: DAEWOO SHIPBUILDING & MARINE ENGINEERING CO., LTD., Geoje-si, Gyeongsangnam-do (KR)

(72) Inventor: In Woong KIM, Seoul (KR)

(73) Assignee: DAEWOO SHIPBUILDING & MARINE ENGINEERING CO., LTD., Geoje-si, Gyeongsangnam-do (KR)

(21) Appl. No.: 15/743,633

(22) PCT Filed: Oct. 20, 2016
(86) PCT No.: PCT/KR2016/011776

§ 371 Date: Jan. 10, 2018

(30) Foreign Application Priority Data
Oct. 23, 2015 (KR) 10-2015-0148207

(51) Int. Cl. F25J 1/00; F25J 1/02; F17C 6/00

(52) U.S. Cl. CPC F25J 1/0025; F25J 1/0092; F25J 1/0294; F25J 1/0296; F17C 5/02; F25J 2230/30; F25J 2230/24; F25J 2230/60; F17C 6/00

(57) ABSTRACT

Disclosed herein is a boil-off gas reliquefaction apparatus. The boil-off gas reliquefaction apparatus includes: a plurality of compressors arranged in parallel to compress boil-off gas discharged from a storage tank; a reliquefaction unit reliquefying the boil-off gas compressed by each of the plurality of compressors; and a plurality of supply lines providing a path through which the boil-off gas is supplied from the plurality of compressors to the reliquefaction unit and a path through which the boil-off gas flows in the reliquefaction unit, wherein the plurality of supply lines is arranged independently of one another without being joined together.

### TECHNICAL FIELD

The present invention relates to an apparatus and method for boil-off gas reliquefaction, and, more particularly, to an apparatus and method for boil-off gas reliquefaction, which can provide easy control of reliquefaction of boil-off gas.

### BACKGROUND ART

A floating marine structure handling liquefied gas such as liquefied natural gas (LNG) and liquefied petroleum gas (LPG) is provided with a liquefied gas storage tank.

Such a storage tank is provided with an insulator preventing heat exchange between the inside and outside of the storage tank. However, since complete insulation of the inside of the storage tank from the outside is impossible, thermal energy is transferred from the outside to the inside, causing evaporation of liquefied gas and thus generation of boil-off gas (BOG).

Since continuous accumulation of boil-off gas in the storage tank can cause deterioration in stability of the storage tank, a floating marine structure handling liquefied gas is often provided with a boil-off gas reliquefaction apparatus.

### DISCLOSURE

### Technical Problem

FIG. 1 is a conceptual diagram of a typical boil-off gas reliquefaction apparatus.

Referring to FIG. 1, the reliquefaction apparatus includes: a plurality of compressors 1 compressing boil-off gas discharged from a storage tank; and a supply line 3 providing a path through which the boil-off gas is supplied from the plurality of compressors 1 to a reliquefaction unit 2 and a path through which the boil-off gas flows in the reliquefaction unit.

When the amount of boil-off gas discharged from the storage tank is small, only some of the plurality of compressors 1 is operated to reliquefy the boil-off gas, whereas, when the amount of boil-off gas discharged from the storage tank is large, all of the plurality of compressors 1 is operated to reliquefy the boil-off gas.

When the boil-off gas compressed by each of the plurality of compressors 1 joins together to be supplied to the reliquefaction unit 2, as shown in FIG. 1, the temperature, flow rate and pressure of the boil-off gas are controlled in a common line through which the boil-off gas having joined together is supplied to the reliquefaction unit 2. Thus, for smooth reliquefaction of boil-off gas, the boil-off gas from the storage tank needs to be equally distributed to the plurality of compressors 1. However, since the amount of boil-off gas discharged from the storage tank changes frequently depending on the pressure inside the storage tank, it is difficult to control the boil-off gas to be equally distributed in real time to the plurality of compressors 1.

The present invention is aimed at providing an apparatus and method for boil-off gas reliquefaction capable of providing smooth reliquefaction of boil-off gas without a need to equally distribute boil-off gas to a plurality of compressors.

### Technical Solution

In accordance with one aspect of the present invention, a boil-off gas reliquefaction apparatus includes: a plurality of compressors arranged in parallel to compress boil-off gas discharged from a storage tank; a reliquefaction unit reliquefying the boil-off gas compressed by each of the plurality of compressors; and a plurality of supply lines providing a path through which the boil-off gas is supplied from the plurality of compressors to the reliquefaction unit and a path through which the boil-off gas flows in the reliquefaction unit, wherein the supply lines are arranged independently of one another without being joined together.

The plurality of compressors may include a first compressor and a second compressor.

The second compressor may act as a redundant compressor of the first compressor.

The reliquefaction unit may include a heat exchanger cooling boil-off gas compressed by each of the plurality of compressors by exchanging heat with boil-off gas discharged from the storage tank, and the boil-off gas discharged from the storage tank is acting as a refrigerant while flowing in the heat exchanger.

The reliquefaction unit may further include a plurality of expansion units decompressing and expanding boil-off gas having been compressed by each of the plurality of compressors and passed through the heat exchanger.

The reliquefaction unit may further include a gas/liquid separator separating a gas-liquid mixture produced through the plurality of compressors, the heat exchanger, and the plurality of expansion units into gas and liquid components.

The gas component separated by the gas/liquid separator may join boil-off gas discharged from the storage tank to be used as a refrigerant in the heat exchanger.

In accordance with another aspect of the present invention, a boil-off gas reliquefaction method includes: 1) compressing, by a plurality of compressors arranged in parallel, boil-off gas discharged from a storage tank; and 2) reliquefying, by a reliquefaction unit, the boil-off gas compressed in step 1), wherein a plurality of supply lines providing a path through which the boil-off gas compressed by each of the plurality of compressors is supplied to the reliquefaction unit and a path through which the boil-off gas flows in the reliquefaction unit are arranged independently of one another without being joined together.

The plurality of compressors may include a first compressor and a second compressor.

The second compressor may act as a redundant compressor of the first compressor.

Step 2) may include 2-1) cooling boil-off gas compressed by each of the plurality of compressors by exchanging heat with boil-off gas discharged from the storage tank, and the boil-off gas discharged from the storage tank is acting as a refrigerant for heat exchange.

Step 2) may further include 2-2) decompressing and expanding the boil-off gas having passed through the step 2-1).

Step 2) may further include 2-3) separating a gas-liquid mixture produced through Step 2-2) into gas and liquid components.

The gas component having been separated in Step 2-3) may join boil-off gas discharged from the storage tank to be used as a refrigerant for heat exchange in step 2-1).

In accordance with a further aspect of the present invention, a boil-off gas reliquefaction method includes: 1) compressing, by a first compressor, a fraction of boil-off gas discharged from a storage tank; 2) compressing, by a second compressor, another fraction of boil-off gas discharged from the storage tank; 3) cooling, by a heat exchanger, both the boil-off gas compressed in Step 1) and boil-off gas compressed in Step 2) by exchanging heat with boil-off gas discharged from the storage tank, and the boil-off gas discharged from the storage tank is acting as a refrigerant while flowing in the heat exchanger; 4) expanding, by a first expansion unit, the boil-off gas having been compressed in step 1) and cooled in Step 3); and 5) expanding, by a second expansion unit, the boil-off gas having been compressed in Step 2) and cooled in Step 3), wherein the boil-off gas compressed by the first compressor does not join the boil-off gas compressed by the second compressor throughout Steps 1) to 5).

The boil-off gas reliquefaction method may further include: 6) separating a fluid having been expanded in Step 4) and a fluid having been expanded in Step 5) into liquefied gas and gaseous boil-off gas, wherein the liquefied gas having been separated in Step 6) may be returned to the storage tank.

The gaseous boil-off gas having been separated in Step 6) may join boil-off gas discharged from the storage tank to be used as a refrigerant for heat exchange in Step 3).

### Advantageous Effects

According to the present invention, a redundant compressor is used in gas reliquefaction of boil-off gas, whereby the required capacity of compressors can be reduced, thereby reducing the cost and footprint of the compressors.

In addition, according to the present invention, plural supply lines are arranged independently of each other, whereby boil-off gas can be smoothly re-liquefied without controlling boil-off gas discharged from a storage tank to be equally distributed to a plurality of compressors.

### DESCRIPTION OF DRAWINGS

FIG. 1 is a conceptual diagram of a typical boil-off gas reliquefaction apparatus.

FIG. 2 is a configuration diagram of a boil-off gas reliquefaction apparatus according to one embodiment of the present invention.

### BEST MODE

Hereinafter, embodiments of the present invention will be described with reference to the accompanying drawings. Although some embodiments will be described herein, it should be understood by those skilled in the art that these embodiments are given by way of illustration only and the present invention is not limited thereto. In addition, it should be understood that various modifications, variations, and alterations can be made by those skilled in the art without departing from the spirit and scope of the present invention. Therefore, the scope of the invention should be limited only by the accompanying claims and equivalents thereof.

The present invention may be applied to a floating marine structure including a liquefied gas storage tank. Herein, “liquefied gas” should be construed as including liquefied natural gas and liquefied petroleum gas.

FIG. 2 is a configuration diagram of a boil-off gas reliquefaction apparatus according to one embodiment of the present invention.

Referring to FIG. 2, a boil-off gas reliquefaction apparatus according to this embodiment includes a first compressor 12, a second compressor 14, a reliquefaction unit 100, a first supply line 22, and a second supply line 24.

In this embodiment, the first compressor 12 and the second compressor 14 serve to compress boil-off gas discharged from a liquefied gas storage tank and are arranged in parallel. Although the boil-off gas reliquefaction apparatus is shown as including two compressors in this embodiment, it should be understood that the present invention is not limited thereto and the boil-off gas reliquefaction apparatus may include three or more compressors arranged in parallel to compress boil-off gas discharged from the storage tank.

In this embodiment, the second compressor 14 may act as a redundant compressor. Generally, redundancy refers to a configuration in which an additional component is provided to perform the same role in case one component does not operate normally due to a failure or the like. In other words, upon malfunction of some components, a component for redundancy can be driven to enable normal operation.

In this embodiment, upon malfunction of the first compressor 12, the second compressor 14 installed for redundancy may compress boil-off gas from the storage tank in place of the first compressor 12.

In addition, even though the second compressor 14 is installed for redundancy, when the first compressor 12 is in normal operation, the second compressor 14 may be operated along with the first compressor 12. For example, when the amount of boil-off gas discharged from the storage tank exceeds the capacity of the first compressor 12, both the first compressor 12 and the second compressor 14 may be operated to compress the boil-off gas.

When the second compressor 14 installed for redundancy is operated along with the first compressor 12, boil-off gas from the storage tank can be completely compressed without increasing the capacity of the first compressor 12, whereby the required capacity of each of the compressors can be reduced, thereby reducing the cost and footprint of the compressors.

In this embodiment, the reliquefaction unit 100 serves to reliquefy boil-off gas compressed by the first compressor 12 and the second compressor 14 and may include a heat exchanger 102.

In this embodiment, the heat exchanger 102 collects cold thermal energy of boil-off gas discharged from the storage tank 5 and serves to cool boil-off gas compressed by the first compressor 12 and boil-off gas compressed by the second compressor 14 using the cold thermal energy of boil-off gas discharged from the storage tank 5. In other words, the heat exchanger 102 cools the boil-off gas compressed by the first compressor 12 and the boil-off gas compressed by the second compressor 14 by exchanging heat with the boil-off gas discharged from the storage tank 5, and the boil-off gas discharged from the storage tank 5 is acting as a refrigerant while flowing in the heat exchanger 102.

In this embodiment, the reliquefaction unit 100 may further include: a first expansion unit 104 decompressing and expanding boil-off gas having been compressed by the first compressor 12 and passed through the heat exchanger 102; and a second expansion unit 106 decompressing and expanding boil-off gas having been compressed by the second compressor 14 and passed through the heat exchanger 102. Each of the first expansion unit 104 and the second expansion unit 106 may be an expansion valve, for example, a Joule-Thomson valve. Although the reliquefaction unit 100 is shown as including two expansion units in this embodiment, it should be understood that the present invention is not limited thereto and the reliquefaction unit 100 may include three or more expansion units, corresponding to the number of compressors, as needed.

In this embodiment, the reliquefaction unit 100 may further include: a gas/liquid separator 108 separating a gas-liquid mixture produced through the first compressor 12, the heat exchanger 102, and the first expansion unit 104 and a gas-liquid mixture produced through the second compressor 14, the heat exchanger 102, and the second expansion unit 106 into gas and liquid components.

In this embodiment, the liquid component separated by the gas/liquid separator 108 may be returned to the storage tank 5 and the gas component separated by the gas/liquid separator 108 may join boil-off gas discharged from the storage tank 5 to be used as a refrigerant in the heat exchanger 102.

In this embodiment, the first supply line 22 serves to provide a path through which boil-off gas compressed by the first compressor 12 is supplied to the reliquefaction unit 100 and a path through which the boil-off gas compressed by the first compressor 12 flows in the reliquefaction unit 100, and the second supply line 24 serves to provide a path through which boil-off gas compressed by the second compressor 14 is supplied to the reliquefaction unit 100 and a path through which the boil-off gas compressed by the second compressor 14 flows in the reliquefaction unit 100.

In this embodiment, the first supply line 22 and the second supply line 24 are independently installed without being joined together. In other words, boil-off gas flowing through the first supply line 22 after being compressed by the first compressor 12 and boil-off gas flowing through the second supply line 24 after being compressed by the second compressor 14 undergo separate reliquefaction processes without being mixed with each other.

When the reliquefaction unit 100 includes the heat exchanger 102, the first expansion unit 104, the second expansion unit 106, and the gas/liquid separator 108, boil-off gas re-liquefied in the first supply line 22 is supplied to the gas/liquid separator 108 after undergoing compression by the first compressor 12, cooling by the heat exchanger 102, and expansion by the first expansion unit 104, and boil-off gas re-liquefied in the second supply line 24 is supplied to the gas/liquid separator 108 after undergoing compression by the second compressor 14, cooling by the heat exchanger 102, and expansion by the second expansion unit 106.

In this embodiment, since the first supply line 22 and the second supply line 24 are independently installed without being joined together, the heat exchanger 102 includes a flow path through which boil-off gas compressed by the first compressor 12 passes, a flow path through which boil-off gas compressed by the second compressor 14 passes, and a flow path through which boil-off gas discharged from storage tank 5 passes.

When the boil-off gas reliquefaction apparatus according to this embodiment includes three or more compressors, the boil-off gas reliquefaction apparatus includes three or more supply lines corresponding thereto, which are independently installed without being joined together.

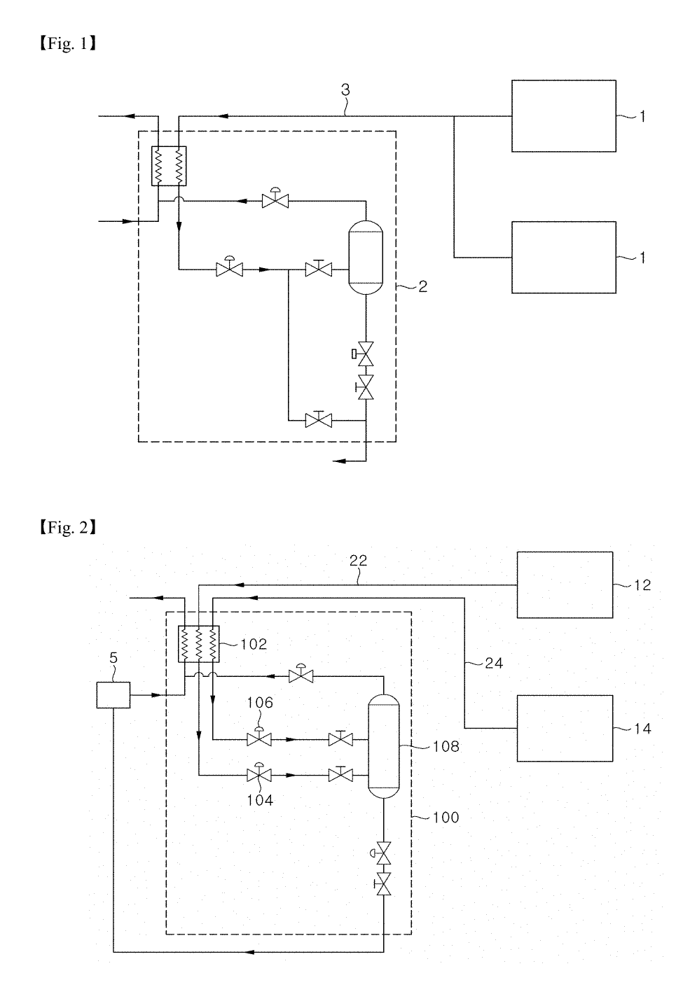

If boil-off gases compressed by each of the plurality of compressors 1 are joined together and then supplied to the reliquefaction unit 3, as shown in FIG. 1, boil-off gas supplied from the storage tank needs to be equally distributed to the plurality of compressors 1. However, since the amount of the boil-off gas discharged from the storage tank changes in real time depending on the internal state of the storage tank, it is difficult and complicated to control the boil-off gas to be equally distributed to the plurality of compressors 1.

According to the present invention, boil-off gas compressed by each of the plurality of compressors 12, 14 is supplied to the reliquefaction unit 100 through the plurality of supply lines 22, 24 installed independently of each other, without being mixed together, as shown in FIG. 2. Thus, the temperature, flow rate and pressure of boil-off gas may be controlled in each of the plurality of supply lines 22, 24 without a need to control the temperature, flow rate and pressure of mixed boil-off gas. Thus, according to the present invention, reliquefaction of boil-off gas can be smoothly performed without equally distributing boil-off gas from the storage tank to the plurality of compressors 12, 14.

In addition, according to the present invention, when a large amount of boil-off gas is discharged from the storage tank, a redundant compressor is further driven for reliquefaction of the boil-off gas, whereby the required capacity of each of the compressors can be reduced, thereby reducing the cost and footprint of the compressors.

1. A boil-off gas reliquefaction apparatus, comprising:
a plurality of compressors arranged in parallel to compress boil-off gas discharged from a storage tank;
a reliquefaction unit reliquefying the boil-off gas compressed by each of the plurality of compressors; and
a plurality of supply lines providing a path through which the boil-off gas is supplied from the plurality of compressors to the reliquefaction unit and a path through which the boil-off gas flows in the reliquefaction unit,
wherein the plurality of supply lines is arranged independently of one another without being joined together.

2. The boil-off gas reliquefaction apparatus according to claim 1, wherein the plurality of compressors comprises a first compressor and a second compressor.

3. The boil-off gas reliquefaction apparatus according to claim 2, wherein the second compressor acts as a redundant compressor of the first compressor.

4. The boil-off gas reliquefaction apparatus according to claim 1, wherein the reliquefaction unit comprises a heat exchanger cooling boil-off gas compressed by each of the plurality of compressors by exchanging heat with boil-off gas discharged from the storage tank, and the boil-off gas discharged from the storage tank is acting as a refrigerant while flowing in the heat exchanger.

5. The boil-off gas reliquefaction apparatus according to claim 4, wherein the reliquefaction unit further comprises a plurality of expansion units decompressing and expanding boil-off gas having been compressed by each of the plurality of compressors and passed through the heat exchanger.

6. The boil-off gas reliquefaction apparatus according to claim 5, wherein the reliquefaction unit further comprises a gas/liquid separator separating a gas-liquid mixture produced through the plurality of compressors, the heat exchanger, and the plurality of expansion units into gas and liquid components.

7. The boil-off gas reliquefaction apparatus according to claim 6, wherein the gas component separated by the gas/liquid separator joins boil-off gas discharged from the storage tank to be used as a refrigerant in the heat exchanger.

8. A boil-off gas reliquefaction method, comprising:
1) compressing, by each of a plurality of compressors arranged in parallel, boil-off gas discharged from a storage tank; and
2) reliquefying, by a reliquefaction unit, the boil-off gas compressed in Step 1), wherein a plurality of supply lines providing a path through which the boil-off gas compressed by each of the plurality of compressors is supplied to the reliquefaction unit and a path through which the boil-off gas flows in the reliquefaction unit is arranged independently of one another without being joined together.

9. The boil-off gas reliquefaction method according to claim 8, wherein the plurality of compressors comprises a first compressor and a second compressor.

10. The boil-off gas reliquefaction method according to claim 9, wherein the second compressor acts as a redundant compressor of the first compressor.

11. The boil-off gas reliquefaction method according to claim 8, wherein Step 2) comprises 2-1) cooling boil-off gas compressed by each of the plurality of compressors by exchanging heat with boil-off gas discharged from the storage tank, and the boil-off gas discharged from the storage tank is acting as a refrigerant for heat exchange.

12. The boil-off gas reliquefaction method according to claim 11, wherein Step 2) further comprises 2-2) decompressing and expanding the boil-off gas having passed through the step 2-1).

13. The boil-off gas reliquefaction method according to claim 12, wherein Step 2) further comprises 2-3) separating a gas-liquid mixture produced through step 2-2) into gas and liquid components.

14. The boil-off gas reliquefaction method according to claim 13, wherein the gas component having been separated in Step 2-3) joins boil-off gas discharged from the storage tank to be used as a refrigerant for heat exchange in step 2-1).

15. A boil-off gas reliquefaction method, comprising:
1) compressing, by a first compressor, a fraction of boil-off gas discharged from a storage tank;
2) compressing, by a second compressor, another fraction of boil-off gas discharged from the storage tank;
3) cooling, by a heat exchanger, both the boil-off gas compressed in Step 1) and boil-off gas compressed in Step 2) by exchanging heat with boil-off gas discharged from the storage tank, and the boil-off gas discharged from the storage tank is acting as a refrigerant while flowing in the heat exchanger;
4) expanding, by a first expansion unit, the boil-off gas having been compressed in step 1) and cooled in Step 3); and
5) expanding, by a second expansion unit, the boil-off gas having been compressed in Step 2) and cooled in Step 3),
wherein the boil-off gas compressed by the first compressor does not join the boil-off gas compressed by the second compressor throughout Steps 1) to 5).

16. The boil-off gas reliquefaction method according to claim 15, further comprising:
6) separating a fluid having been expanded in Step 4) and a fluid having been expanded in Step 5) into liquefied gas and gaseous boil-off gas,
wherein the liquefied gas having been separated in Step 6) is returned to the storage tank.

17. The boil-off gas reliquefaction method according to claim 16, wherein the gaseous boil-off gas having been separated in Step 6) joins boil-off gas discharged from the storage tank to be used as a refrigerant for heat exchange in Step 3).
